(19) United States
(12) Patent Application Publication
(10) Pub. No.: US 2024/0400123 A1
(43) Pub. Date: Dec. 5, 2024

(54) MODULAR STROLLER WAGON

(71) Applicant: Kids2, LLC, Atlanta, GA (US)

(72) Inventors: Dana E. CHICCA, Somerset, MA (US); Sean FOSTER, West Warwick, RI (US); Robert BLACKADAR, Worcester, MA (US)

(21) Appl. No.: 18/738,613

(22) Filed: Jun. 10, 2024

Related U.S. Application Data
(63) Continuation of application No. PCT/US2022/081304, filed on Dec. 9, 2022.
(60) Provisional application No. 63/288,233, filed on Dec. 10, 2021.

(51) Int. Cl. B62B 7/06

(52) U.S. Cl. CPC B62B 7/062

(57) ABSTRACT

A modular stroller having a wagon-like configuration. The stroller includes a collapsible frame having a handle portion front and rear body portions and a bottom body portion, and a foldable receptacle body configured to receive a child's body thereon. The foldable receptacle body is configured to be removably securable within the collapsible frame. The modular wagon stroller is movable between (1) a fully open position, (2) a partially folded position, and (3) a fully folded (i.e., closed) position.

### RELATED APPLICATION

This application claims the benefit of priority to U.S. Provisional Patent Application No. 63/288,233, filed Dec. 10, 2021, the disclosure of which is incorporated by reference herein in its entirety.

### FIELD OF THE INVENTION

The invention relates to strollers, and more particularly, to modular strollers with multiple modes of use to accommodate infants and toddlers of different ages.

### BACKGROUND OF THE INVENTION

Strollers with collapsible frames/constructions are known. It is desirable to have such a stroller that is modular, and thereby includes multiple modes of operation.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In one aspect, the invention includes a modular wagon stroller that comprises a collapsible frame and a foldable receptacle body including a sidewall and a base surrounded by the sidewall and configured to receive a child's body thereon, the foldable receptacle body structure being configured to be removably securable within the collapsible frame. The foldable receptacle body is moveable between an angled forward-facing position, an angled rearward-facing position, a flat position and a wagon position defining a wagon-like space. The collapsible frame includes a handle portion having a first pair of generally parallel members, a front body portion, a rear body portion and a bottom body portion. The front body portion includes a second pair of generally parallel members each having an upper end attached to a portion of each of the first pair of generally parallel members, respectively, and a lower end rotatably engaging the bottom body portion at respective first points. The rear body portion includes a third pair of generally parallel members each having an upper end rotatably engaging a lower end of each of the first pair of generally parallel members, respectively, and a lower end rotatably engaging the bottom body portion at respective second points. The modular wagon stroller is movable between (1) a fully open position, (2) a partially folded position, and (3) a fully folded position.

In another aspect, the invention includes a modular wagon stroller that comprises a collapsible frame including a handle portion having a first pair of generally parallel members, a front body portion, a rear body portion and a bottom body portion; and a foldable receptacle body including a sidewall and a base surrounded by the sidewall and configured to receive a child's body thereon. The foldable receptacle body is configured to be removably securable within the collapsible frame. The modular wagon stroller is movable between (1) a fully open position, (2) a partially folded position, and (3) a fully folded position. The front body portion includes a second pair of generally parallel members each having an upper end attached to a portion of each of the first pair of generally parallel members, respectively, and a lower end rotatably engaging the bottom body portion at respective first points. The rear body portion includes a third pair of generally parallel members each having an upper end rotatably engaging a lower end of each of the first pair of generally parallel members, respectively, and a lower end rotatably engaging the bottom body portion at respective second points.

These and other features, aspects, and advantages of the present invention will become better understood with reference to the following description, appended claims, and accompanying drawings.

### BRIEF DESCRIPTION OF THE DRAWINGS

Embodiments of the invention are further described but are in no way limited by the following illustrations.

FIG. 1 is a top perspective view of a modular wagon stroller according to a first embodiment of the invention as configured in a forward-facing infant car seat mode;

FIG. 2 is a top perspective view of the modular wagon stroller of FIG. 1 as configured in a rearward-facing infant car seat mode;

FIG. 3 is a top perspective view of a modular wagon stroller according to a second embodiment of the invention as configured in a forward-facing toddler mode;

FIG. 4 is a top perspective view of the modular wagon stroller of FIG. 3 as configured in a rearward-facing toddler mode;

FIG. 5 is a top perspective view of the modular wagon stroller of FIG. 3 as configured in a carriage/flat mode;

FIG. 6 is a top perspective view of the modular wagon stroller of FIG. 3 as configured in a wagon mode;

FIG. 7 is a top perspective view of the modular wagon stroller of FIG. 3 undergoing a first step of folding from the wagon mode; and

FIG. 8 is a top perspective view of the modular wagon stroller of FIG. 3 undergoing a second/subsequent step of folding from the wagon mode.

### DETAILED DESCRIPTION OF THE INVENTION

For clarity and convenience, the meaning of some terms and phrases used in the specification, examples, and appended claims, are provided below. Unless stated otherwise, or implicit from context, the following terms and phrases include the meanings provided below. The definitions are provided to aid in describing particular embodiments, and are not intended to limit the claimed invention, because the scope of the invention is limited only by the claims. Unless otherwise defined, all technical and scientific terms used herein have the same meaning as commonly understood by one of ordinary skill in the art to which this invention belongs. If there is an apparent discrepancy between the usage of a term in the art and its definition provided herein, the definition provided within the specification shall prevail.

As used in this specification and the appended claims, the singular forms “a,” “an” and “the” include plural referents unless the content clearly dictates otherwise.

As used herein, the term “approximately” or “about” in reference to a value or parameter are generally taken to include numbers that fall within a range of 5%, 10%, 15%, or 20% in either direction (greater than or less than) of the number unless otherwise stated or otherwise evident from the context (except where such number would be less than 0% or exceed 100% of a possible value). As used herein, reference to “approximately” or “about” a value or parameter includes (and describes) embodiments that are directed to that value or parameter. For example, description referring to “about X” includes description of “X”.

As used herein, the term “or” means “and/or.” The term “and/or” as used in a phrase such as “A and/or B” herein is intended to include both A and B; A or B; A (alone); and B (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

As used herein, the term “comprising” means that other elements can also be present in addition to the defined elements presented. The use of “comprising” indicates inclusion rather than limitation.

The term “consisting of” refers to compositions, methods, and respective components thereof as described herein, which are exclusive of any element not recited in that description of the embodiment.

Disclosed herein is a modular wagon stroller that has a collapsible frame/construction and multiple modes of use.

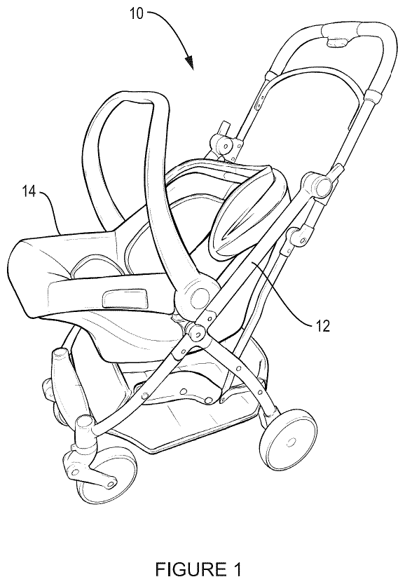

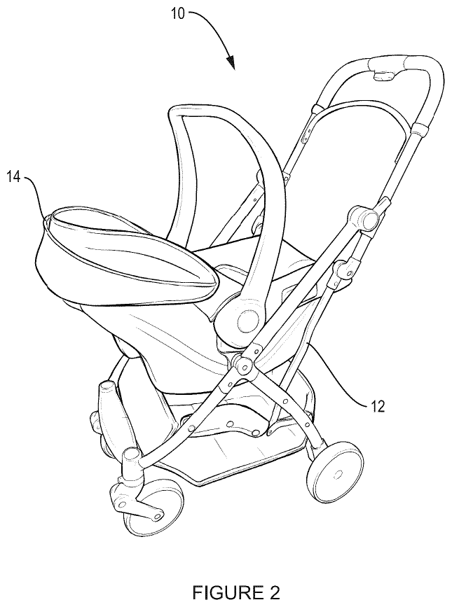

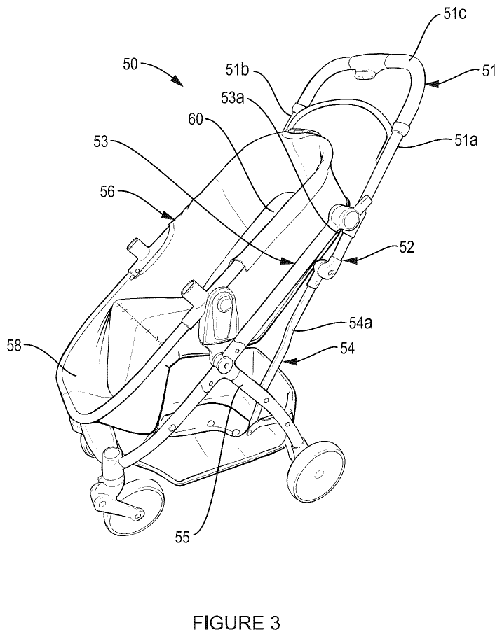

FIGS. 1 and 2 show a modular wagon stroller 10 according to first embodiment of the invention. The modular wagon stroller 10 includes a collapsible frame 12 and a removeable infant car seat 14 that is removably securable within the frame 12. FIG. 1 shows the modular wagon stroller 10 with the infant car seat 14 secured therein in a forward-facing position (i.e., wherein the infant occupying the car seat 14 is facing forward, and away from the person pushing the stroller wagon 10). FIG. 2 shows the modular wagon stroller 10 with the infant car seat 14 secured therein in a rearward-facing position (i.e., wherein the infant occupying the car seat 14 is facing backwards with respect and towards the person pushing the stroller wagon 10). The operation and components of the frame 12 are the same as, or generally similar to, the frame of the embodiment of the modular wagon stroller discussed immediately below and shown in FIGS. 3-8.

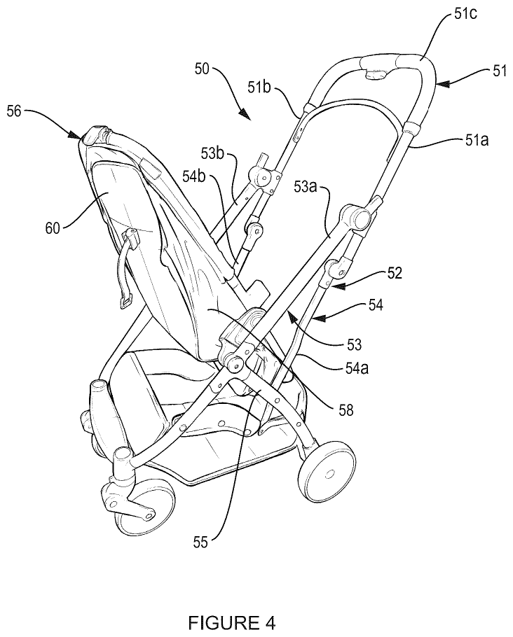

FIGS. 3 and 4 show a modular wagon stroller 50 according to another (second) embodiment including a foldable receptacle body/containment structure 56 that is removably securable within a collapsible frame 52. The frame 52 includes a generally U-shaped handle portion 51 having generally parallel members 51a and 51b and a transverse member 51c extending between members 51a, 51b. The frame 52 also includes a front body portion 53, a rear body portion 54 and a bottom body portion 55. The front body portion 53 includes generally parallel members 53a, 53b that each have an upper end attached to a portion of the members 51a, 51b of the handle portion 51, respectively, and a lower end rotatably engaging the bottom body portion 55 at respective first points (e.g., via hinges, screws or other means). The rear body portion 54 has generally parallel members 54a, 54b that each have an upper end rotatably engaging a lower end of the members 51a, 51b of the handle portion 51, respectively (e.g., via hinges, screws or other means), and a lower end rotatably engaging the bottom body 55 portion at respective second points (e.g., via hinges, screws or other means). The foldable receptacle body/containment structure 56 includes a generally oblong or rounded rectangular sidewall 58 and a generally oblong base 60 surrounded by the sidewall 58 and configured to receive a child's body thereon.

FIG. 3 shows the modular wagon stroller 50 with the foldable receptacle body/containment structure 56 secured therein in an angled forward-facing position (i.e., wherein the child occupying the foldable receptacle body/containment structure 16 is facing forward, and away from the person pushing the stroller wagon 50). FIG. 4 shows the modular wagon stroller 50 with the foldable receptacle body/containment structure 56 secured therein in an angled rearward-facing position (i.e., wherein the child occupying the foldable receptacle body/containment structure 56 is facing backwards with respect and towards the person pushing the stroller wagon 50).

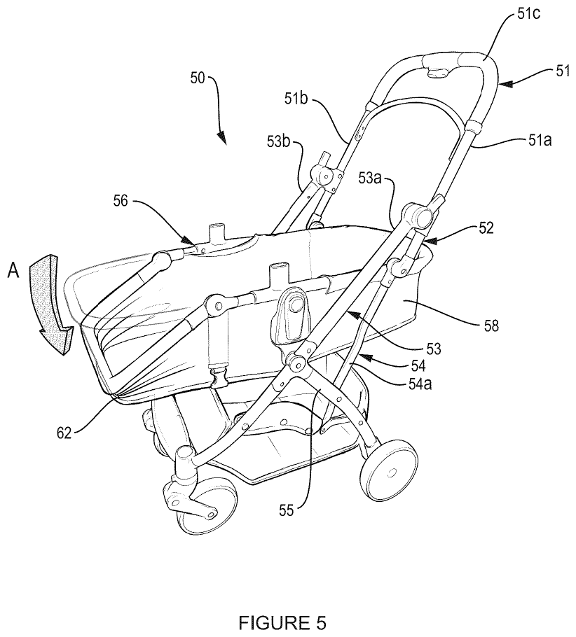

FIG. 5 shows the modular wagon stroller 50 as configured in a carriage/flat mode, with the foldable receptacle body/containment structure 56 in a flat position. The sidewall 58 of the foldable receptacle body/containment structure 56 includes at least one end portion 62 that is configured to be foldable. The arrow A shows the end portion 62 being folding down.

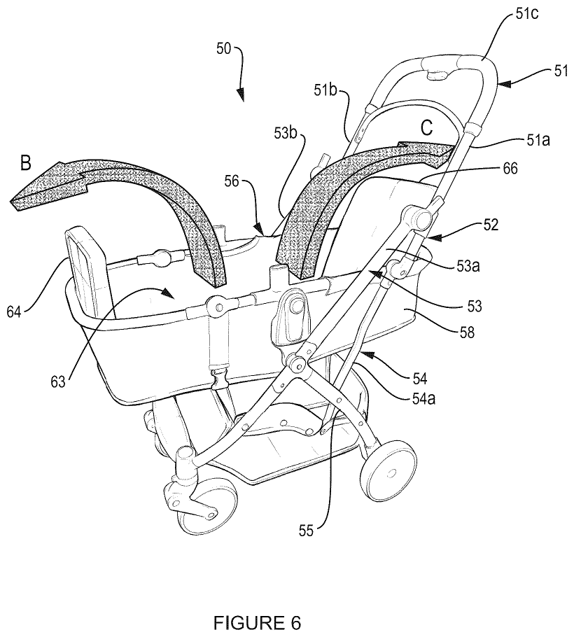

FIG. 6 shows the modular wagon stroller 50 as configured in a wagon mode. The receptacle body/containment structure 56 (i.e., its sidewall 58 and base 60) is arranged to define a wagon-like space 63, enabling the modular wagon stroller 50 to function as a wagon (e.g., wagons manufactured by/sold under the name Radio Flyer®). The wagon-like space 63 can be used to transport two children (e.g., toddlers) in a face-to-face configuration, or one child and one pet (e.g., a dog), or only one child. The wagon-like space 63 need not be used to transport infants, toddlers or other children. The wagon-like space 63 can also be used exclusively for one or more pets, and/or for carrying inanimate objects/belongings/equipment (e.g., beach items, athletic equipment, etc.).

As also shown in FIG. 6, the base 60 of the foldable receptacle body/containment structure 56 is configured to include rotatable end cushion members 64, 66 that fold upwards (see Arrows B and C) to abut the opposed inside end surfaces of the sidewall 58. The end cushion members 64, 66 provide a seat backing for one or two children travelling in the receptacle body/containment structure 56.

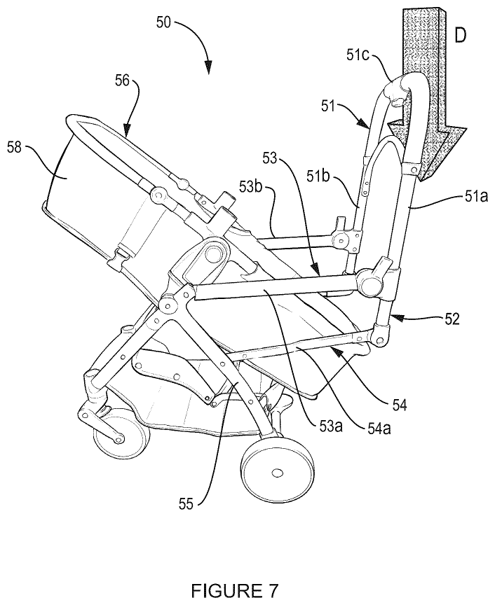

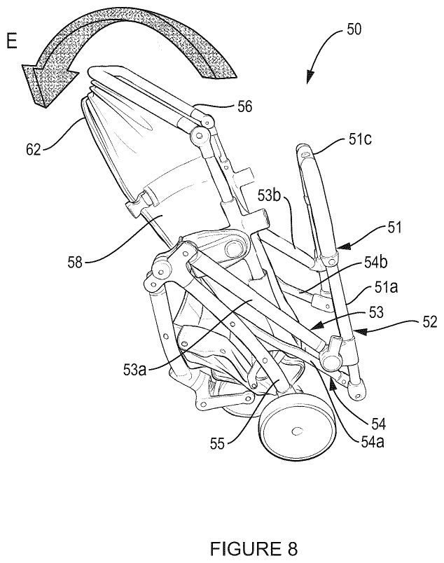

FIGS. 7 and 8 show the modular wagon stroller 50 being folded from an open position to a partially folded position, and then to a folded (i.e., closed) position. In FIG. 7, a downward force (shown by Arrow D) is applied to the handle portion 51 of the frame 52 to fold the modular wagon stroller 50 into its partially folded position. More particularly, the handle portion 51 is moved downwardly to decrease the angle between each of the handle portion members 51a, 51b and each of the respective members 54a, 54b of the rear body portion 54. In one embodiment, this angle is decreased from about 180° to about 90° (see FIG. 7). This downward force and resulting motion also decrease the angle between each of the members 53a, 53b of the front body portion 53 and bottom body portion 55 (e.g., members thereof). In one embodiment, this angle is decreased from about 90° to about 45° (see FIG. 7). Further, this downward force and resulting motion also decrease the angle between each of the members 54a, 54b of the rear body portion 54 and the bottom body portion 55 (e.g., members thereof). In one embodiment, this angle is decreased from about 90° to about 45° (see FIG. 7). In FIG. 8, continued force (shown by Arrow E) is applied to the handle portion 51 of the frame 52 to fold the modular wagon stroller 50 into its closed position. More particularly, the handle portion 51 is moved towards the bottom body portion 55 to further decrease the angle between each of the handle portion members 51a, 51b and each of the respective members 54a, 54b of the rear body portion 54. In one embodiment, this angle is decreased from about 90° to less than about 45° (see FIG. 8). This force and resulting motion also decrease the angle between each of the members 53a, 53b of the front body portion 53 and the bottom body portion 55 (e.g., members thereof). In one embodiment, this angle is decreased from about 45° to less than about 45°. Further, this force and resulting motion also decrease the angle between each of the members 54a, 54b of the rear body portion 54 and the bottom body portion 55 (e.g., members thereof). In one embodiment, this angle is decreased from about 45° to less than about 45°.

The closed (i.e., folded) position of the modular wagon stroller 50 facilitates easy transport and storage/stowage. When not in use, being transported or stored/stowed, the modular wagon stroller 50 can be folded and made more compact. When the modular stroller 50 is to be used again, it is opened for use by simply reversing the above steps.

Components of the modular wagon stroller 10 and 50 discussed above are constructed from sturdy but lightweight materials, facilitating easy transportation, lifting and storage.

In general, any combination of disclosed features, components and methods described herein is possible. Steps of a method can be performed in any order that is physically possible.

Although embodiments have been disclosed, the invention is not limited thereby.

We claim:

1. A modular wagon stroller comprising:
a collapsible frame including:
a handle portion having a first pair of generally parallel members;
a front body portion;
a rear body portion;
a bottom body portion;
the front body portion including a second pair of generally parallel members each having an upper end attached to a portion of each of the first pair of generally parallel members, respectively, and a lower end rotatably engaging the bottom body portion at respective first points;
the rear body portion including a third pair of generally parallel members each having an upper end rotatably engaging a lower end of each of the first pair of generally parallel members, respectively, and a lower end rotatably engaging the bottom body portion at respective second points; and
a foldable receptacle body including a sidewall and a base surrounded by the sidewall and configured to receive a child's body thereon, the foldable receptacle body structure being configured to be removably securable within the collapsible frame.

2. The modular wagon stroller of claim 1, wherein the modular wagon stroller is movable between (1) a fully open position, (2) a partially folded position, and (3) a fully folded position.

3. The modular wagon stroller of claim 2, wherein a first angle is formed between each of the first pair of the generally parallel members and each of the respective third pair of generally parallel members.

4. The modular wagon stroller of claim 3, wherein the first angle is about 180° when the modular wagon stroller is in the fully open position, wherein the first angle is about 90° when the modular wagon stroller is in the partially folded position, and wherein the first angle in is about 45° the modular wagon stroller is in the fully folded position.

5. The modular wagon stroller of claim 2, wherein a second angle is formed between each of the second pair of generally parallel members and respective members of the bottom body portion proximate the respective first points.

6. The modular wagon stroller of claim 5, wherein the second angle is about 90° when the modular wagon stroller is in the fully open position, wherein the second angle is about 45° when the modular wagon stroller is in the partially folded position, and wherein the second angle in less than about 45° the modular wagon stroller is in the fully folded position.

7. The modular wagon stroller of claim 2, wherein a third angle is formed between each of the third pair of generally parallel members and respective members of the bottom body portion the respective second points.

8. The modular wagon stroller of claim 7, wherein the third angle is about 90° when the modular wagon stroller is in the fully open position, wherein the third angle is about 45° when the modular wagon stroller is in the partially folded position, and wherein the third angle in less than about 45° the modular wagon stroller is in the fully folded position.

9. The modular wagon stroller of claim 1, wherein the foldable receptacle body is moveable between an angled forward-facing position, an angled rearward-facing position, a flat position and a wagon position defining a wagon-like space.

10. The modular wagon stroller of claim 1, wherein the foldable receptacle body includes rotatable end cushion members configured to fold upwards to abut opposed inside end surfaces of the sidewall and provide a seat backing.

11. The modular wagon stroller of claim 1, wherein the handle portion includes a transverse member extending between each of the first pair of generally parallel members.

12. A modular wagon stroller comprising:
a collapsible frame including:
a handle portion having a first pair of generally parallel members;
a front body portion;
a rear body portion; and
a bottom body portion; and
a foldable receptacle body including a sidewall and a base surrounded by the sidewall and configured to receive a child's body thereon, the foldable receptacle body being configured to be removably securable within the collapsible frame;
wherein the modular wagon stroller is movable between (1) a fully open position, (2) a partially folded position, and (3) a fully folded position.

13. The modular wagon stroller of claim 12,
wherein the front body portion includes a second pair of generally parallel members each having an upper end attached to a portion of each of the first pair of generally parallel members, respectively, and a lower end rotatably engaging the bottom body portion at respective first points; and
wherein the rear body portion includes a third pair of generally parallel members each having an upper end rotatably engaging a lower end of each of the first pair of generally parallel members, respectively, and a lower end rotatably engaging the bottom body portion at respective second points.

14. The modular wagon stroller of claim 13, wherein a first angle is formed between each of the first pair of the generally parallel members and each of the respective third pair of generally parallel members.

15. The modular wagon stroller of claim 14, wherein the first angle is about 180º when the modular wagon stroller is in the fully open position, wherein the first angle is about 90° when the modular wagon stroller is in the partially folded position, and wherein the first angle in is about 45° the modular wagon stroller is in the fully folded position.

16. The modular wagon stroller of claim 13, wherein a second angle is formed between each of the second pair of generally parallel members and respective members of the bottom body portion proximate the respective first points.

17. The modular wagon stroller of claim 16, wherein the second angle is about 90° when the modular wagon stroller is in the fully open position, wherein the second angle is about 45° when the modular wagon stroller is in the partially folded position, and wherein the second angle in less than about 45° the modular wagon stroller is in the fully folded position.

18. The modular wagon stroller of claim 13, wherein a third angle is formed between each of the third pair of generally parallel members and respective members of the bottom body portion the respective second points.

19. The modular wagon stroller of claim 18, wherein the third angle is about 90° when the modular wagon stroller is in the fully open position, wherein the third angle is about 45° when the modular wagon stroller is in the partially folded position, and wherein the third angle in less than about 45° the modular wagon stroller is in the fully folded position.

20. The modular wagon stroller of claim 12, wherein the foldable receptacle body is moveable between an angled forward-facing position, an angled rearward-facing position, a flat position and a wagon position defining a wagon-like space.
